(19) United States
(12) Patent Application Publication
(10) Pub. No.: US 2024/0338750 A1
(43) Pub. Date: Oct. 10, 2024

(54) SERVER DEVICE AND METHOD

(71) Applicant: TOSHIBA TEC KABUSHIKI KAISHA, Shinagawa-ku (JP)

(72) Inventors: Makoto Hatasa, Shizuoka Shizuoka (JP); Kazuki Nakamura, Ota Tokyo (JP)

(21) Appl. No.: 18/393,753

(22) Filed: Dec. 22, 2023

(30) Foreign Application Priority Data
Apr. 7, 2023 (JP) 2023-062968

(51) Int. Cl. G06Q 30/0601; G06Q 10/087

(52) U.S. Cl. CPC G06Q 30/0633; G06Q 10/087; G06Q 30/0641

(57) ABSTRACT

According to one embodiment, a server device and a method capable of improving convenience for an order and settlement of merchandise sold in a plurality of stores are provided. The server device includes: a first reception unit configured to receives, from a user terminal, order information instructing merchandise as an order target selected from merchandise sold in a plurality of stores; a second reception unit configured to receive, from the user terminal, a settlement type instructing a settlement method for the merchandise; and a settlement unit configured to settle a total price of the merchandise instructed by the order information with the instructed settlement type.

### CROSS-REFERENCE TO RELATED APPLICATION

This application is based upon and claims the benefit of priority from Japanese Patent Application No. 2023-062968, filed Apr. 7, 2023, the entire contents of which are incorporated herein by reference.

### FIELD

Embodiments described herein relate to a server device and a method.

### BACKGROUND

In the related art, in a facility such as a shopping center, a restaurant street called a food court is provided. In the food court, a self-service type service is provided in which, after an order and settlement of merchandise are completed in a desired store from among a plurality of stores (restaurants), a user himself or herself carries the merchandise to eat or drink.

In recent years, there is a system that allow a user to order merchandise and perform settlement by using a terminal device such as a smartphone owned by the user.

In the store described above, only a specific settlement type may be used. For example, it is assumed that a plurality of stores that are located in the food court may have different settlement types. In such a case, if the above-described system is used, the user performs settlement of the merchandise while changing the settlement type for each store, which causes problems such as complicated operations and lack of convenience. It is also difficult to place orders and perform settlement over a plurality of stores at once.

### DESCRIPTION OF THE DRAWINGS

FIG. 1 is a diagram showing an example of a configuration of an order system according to an embodiment;

FIG. 2 is a diagram showing an example of a hardware configuration of a user terminal;

FIG. 3 is a diagram showing an example of a hardware configuration of a server device;

FIG. 4 is a diagram showing an example of a data configuration of a store information table;

FIG. 5 is a diagram showing an example of a data configuration of a menu management table;

FIG. 6 is a diagram showing an example of a data configuration of an order management table;

FIG. 7 is a diagram showing an example of a hardware configuration of a store terminal;

FIG. 8 is a diagram showing an example of functional configurations of the user terminal, the server device, and the store terminal;

FIG. 9 is a diagram showing an example of a GUI displayed on a display unit of the user terminal;

FIG. 10 is a diagram showing an example of a GUI;

FIG. 11 is a diagram showing an example of a GUI;

FIG. 12 is a diagram showing an example of a GUI;

FIG. 13 is a diagram explaining an operation example of the order system;

FIG. 14 is a diagram explaining an operation example;

FIG. 15 is a flowchart showing an example of order reception performed by the server device;

FIG. 16 is a flowchart showing an example of order cancellation;

FIG. 17 is a diagram showing an example of a data configuration of a store information table according to a first modification; and

FIG. 18 is a diagram showing an example of a functional configuration of a server device.

### DETAILED DESCRIPTION

An embodiment provides a server device and a method capable of improving convenience for an order and settlement of merchandise sold in a plurality of stores.

In general, according to one embodiment, a server device includes a first reception unit, a second reception unit, and a settlement unit. The first reception unit receives, from a user terminal, order information indicating merchandise as an order target selected from merchandise sold in a plurality of stores. The second reception unit receives, from the user terminal, a settlement type indicating a settlement method for the merchandise. The settlement unit settles a total price of the merchandise indicated by the order information with the settlement type indicated by settlement information.

Hereinafter, a server device and a program according to an embodiment will be described with reference to the drawings. In the embodiment described below, an example in which the present disclosure is applied to a food court in a commercial facility such as a shopping center will be described. The present disclosure is not limited to the embodiment described below.

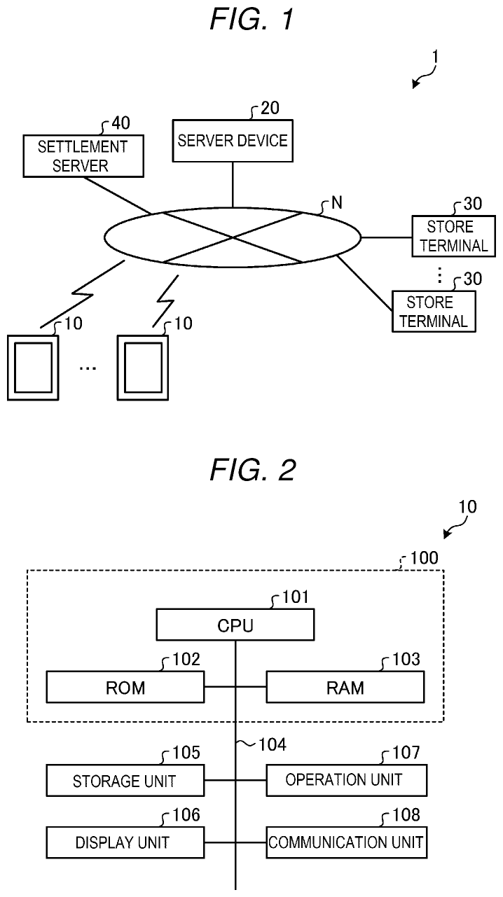

FIG. 1 is a diagram showing an example of a configuration of an order system according to the present embodiment. As shown in FIG. 1, an order system 1 includes user terminals 10, a server device 20, store terminals 30, and a settlement server 40. The user terminals 10, the server device 20, and the store terminals 30 are communicably connected to each other via a network N such as a local area network (LAN) or a public line in a facility. The server device 20 and the settlement server 40 are communicably connected to each other via the network N.

The user terminal 10 is an example of a user terminal. The user terminal 10 is a terminal device used by a customer who uses the food court (hereinafter, also referred to as a user). The user terminal 10 may be a terminal device such as a smartphone or a tablet terminal owned by the customer.

In the present embodiment, the user terminal 10 is used for an order of merchandise sold in a store in the food court (hereinafter also referred to as an order). Specifically, the user terminal 10 accesses the server device 20 to acquire menu information in which merchandise names, prices, and the like of merchandise provided by respective stores are registered. The user terminal 10 also displays a GUI for assisting selection of merchandise as an order target based on the menu information. If the merchandise as the order target is selected by a user operation, the user terminal 10 transmits order information indicating the merchandise to the server device 20.

In the food court, it is common to pay for merchandise when ordering the merchandise. Therefore, the user terminal 10 displays the GUI for assisting payment of the merchandise when ordering the merchandise. The user terminal 10 cooperates with the server device 20 to execute a process for paying for the merchandise as the order target.

The user terminal 10 can instruct cancellation of an order for the ordered merchandise. Upon receiving a cancellation operation for the ordered merchandise, the user terminal 10 cancels the order by transmitting cancellation information instructing the merchandise as a target of the cancellation operation to the server device 20.

The server device 20 is an example of a server device. The server device 20 is provided in a commercial facility or outside the commercial facility, and is communicably connected to the user terminal 10, the store terminal 30, the settlement server 40, and the like via the network N.

In the present embodiment, the server device 20 is implemented by a single device, but may be a cloud server (or a cloud system) implemented by a plurality of devices connected to a network. If the server device 20 is implemented as a cloud server configuration, the server device 20 may include the settlement server 40.

The server device 20 cooperates with the user terminal 10 and the store terminal 30 to execute various data processes related to the order of the merchandise. For example, the server device 20 provides, to the user terminal 10, menu information on merchandise sold in stores that are located in the food court. The server device 20 receives order information instructing the merchandise as the order target from the user terminal 10, and notifies the store terminal 30 in the store in which the instructed merchandise is sold of an order content. The server device 20 cooperates with the settlement server 40 to execute a settlement process for merchandise ordered from the user terminal 10.

Upon receiving an instruction to cancel the ordered merchandise from the user terminal 10, the server device 20 notifies the store terminal 30 in a corresponding store of cancellation of the instructed merchandise. The server device 20 executes a process for refunding a price of the merchandise for which cancellation is instructed.

The store terminal 30 is a terminal device in a store in the food court. Upon receiving a notification of the order content from the server device 20, the store terminal 30 displays the notified order content to inform a store clerk in the store. Upon receiving the notification of cancellation of the order from the server device 20, the store terminal 30 performs display for informing the store clerk of the merchandise as a cancellation target, based on the notified content.

The store terminal 30 may be any device that can display the order content received by the server device 20. For example, the store terminal 30 may be a terminal having a display function and a communication function for communicating with an external device, a POS terminal, a handy terminal owned by a store clerk, or a kitchen display disposed in a kitchen.

The settlement server 40 is a server device operated by a provider of a settlement substituting service for substituting electronic settlement. The settlement server 40 performs electronic settlement based on data provided from the server device 20. The settlement server 40 may be operated by a settlement service provider (credit card company or the like).

Next, hardware configurations of the user terminal 10, the server device 20, and the store terminal 30 will be described.

FIG. 2 is a diagram showing an example of the hardware configuration of the user terminal 10. As shown in FIG. 2, the user terminal 10 includes a central processing unit (CPU) 101, a read only memory (ROM) 102, and a random access memory (RAM) 103.

The CPU 101 is an example of a processor and comprehensively controls an operation of the user terminal 10.

The ROM 102 stores various programs. The RAM 103 is a workspace for expanding programs and various types of data. The CPU 101, the ROM 102, and the RAM 103 are connected via a bus 104, and constitute a control unit 100 of a computer configuration. In the control unit 100, the CPU 101 operates in accordance with a program stored in the ROM 102 or a storage unit 105 and expanded in the RAM 103 to execute various processes.

The control unit 100 is connected to the storage unit 105, a display unit 106, an operation unit 107, a communication unit 108, and the like via the bus 104.

The storage unit 105 is implemented by a hard disk drive (HDD), a flash memory, or the like, and maintains storage contents even when power is cut off. The storage unit 105 stores various programs executed by the CPU 101 and various types of setting information related to an operation of the user terminal 10. For example, the storage unit 105 stores an application program that allows an order of merchandise or the like in cooperation with the server device 20.

The display unit 106 is a display device such as an LCD, and displays various types of information under control of the control unit 100. The operation unit 107 includes various operation buttons and outputs key information corresponding to an operation of an operator to the control unit 100. In the present embodiment, the operation unit 107 includes at least a touch panel on a surface of the display unit 106.

The communication unit 108 is a wired or wireless communication interface that can be connected to the network N. The communication unit 108 communicates with an external device such as the server device 20 or the store terminal 30 via the network N.

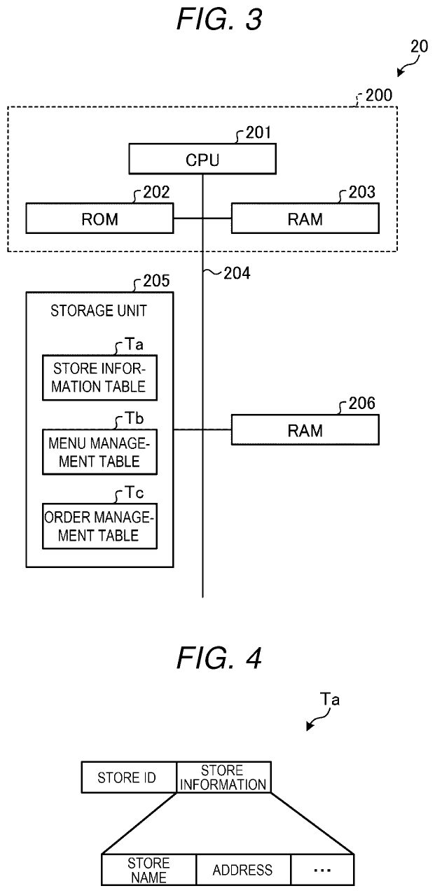

FIG. 3 is a diagram showing an example of the hardware configuration of the server device 20. As shown in FIG. 3, the server device 20 includes a CPU 201, a ROM 202, and a RAM 203.

The CPU 201 is an example of a processor and comprehensively controls an operation of the server device 20. The ROM 202 stores various programs. The RAM 203 is a workspace for expanding programs and various types of data. The CPU 201, the ROM 202, and the RAM 203 are connected via a bus 204 to constitute a control unit 200 having a computer configuration. In the control unit 200, the CPU 201 operates in accordance with a program stored in the ROM 202 or a storage unit 205 and expanded in the RAM 203 to execute various processes.

The control unit 200 is connected to the storage unit 205 and a communication unit 206 via the bus 204. The storage unit 205 is implemented by an HDD, a flash memory, or the like, and maintains storage contents even when the power is cut off. The storage unit 205 stores various programs executed by the CPU 201 and various types of setting information related to the operation of the server device 20. The storage unit 205 stores a store information table Ta, a menu management table Tb, an order management table Tc, and the like.

The store information table Ta is a data table for storing and managing information related to a store that is located in the food court. FIG. 4 is a diagram showing an example of a data configuration of the store information table Ta. As shown in FIG. 4, the store information table Ta stores store information related to a store in correlation with a store ID for identifying the store.

The store information includes items such as a store name and an address of the store terminal 30. Here, in the store name item, information indicating a store name, a trade name, an abbreviation, or the like of a store corresponding to a store ID is registered. In the address item, connection destination information such as an IP address of the store terminal 30 is registered.

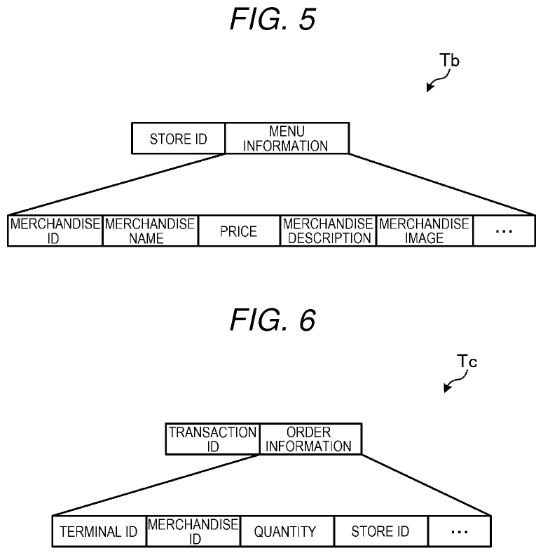

The menu management table Tb is a data table for storing and managing information related to a menu of merchandise sold in the store. FIG. 5 is a diagram showing an example of a data configuration of the menu management table Tb. As shown in FIG. 5, the menu management table Tb stores menu information on merchandise sold in the store in correlation with the store ID of the store.

The menu information includes, for example, items such as a merchandise ID, a merchandise name, a price, merchandise description, and a merchandise image. The merchandise ID is identification information for identifying merchandise. The merchandise name is information indicating a name or abbreviation of the merchandise. The price is information indicating a price per item of the merchandise. The merchandise description stores various types of information related to the merchandise. For example, information related to ingredients in the merchandise is stored in the merchandise description. The merchandise image is image data representing the merchandise.

The order management table Tc is a data table for storing and managing order information received from the user terminal 10. FIG. 6 is a diagram showing an example of a data configuration of the order management table Tc. As shown in FIG. 6, the order management table Tc stores order information in correlation with a transaction ID.

Here, the transaction ID is a unique identifier dispensed for each order (each transaction). The order information includes a terminal ID of the user terminal 10 as a transmission source, a merchandise ID and quantity of the merchandise as the order target, a store ID of the store in which the merchandise is sold, and the like. The terminal ID is information enabling identification of the user terminal 10 or a user who operates the user terminal 10. In the present embodiment, the terminal ID also serves as connection destination information when accessing the user terminal 10, such as a telephone number and an IP address.

Referring back to FIG. 3, the communication unit 206 is a wired or wireless communication interface that can be connected to the network N. The communication unit 206 communicates with external devices such as the user terminal 10, the store terminal 30, and the settlement server 40 via the network N.

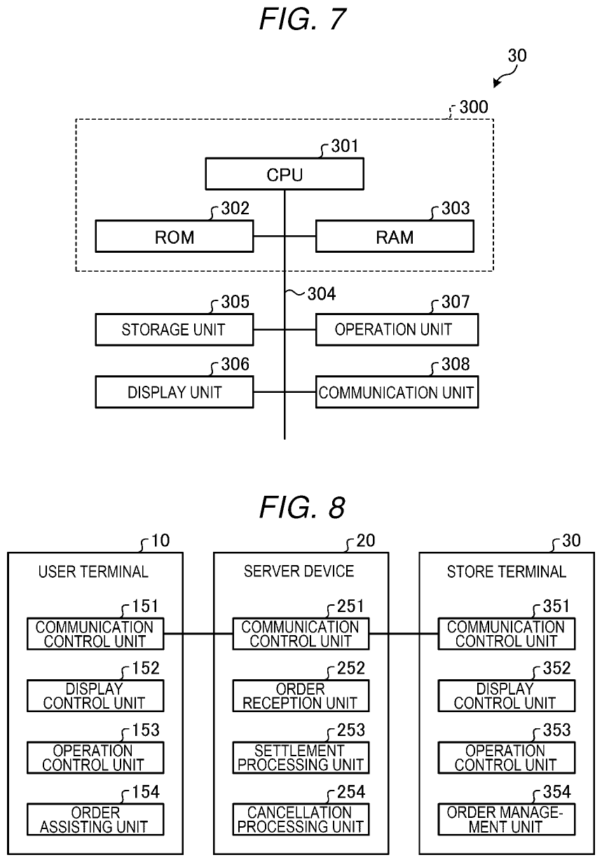

FIG. 7 is a diagram showing an example of the hardware configuration of the store terminal 30. As shown in FIG. 7, the store terminal 30 includes a CPU 301, a ROM 302, and a RAM 303.

The CPU 301 is an example of a processor and comprehensively controls an operation of the store terminal 30. The ROM 302 stores various programs. The RAM 303 is a workspace for expanding programs and various types of data. The CPU 301, the ROM 302, and the RAM 303 are connected via a bus 304, and constitute a control unit 300 having a computer configuration. In the control unit 300, the CPU 301 operates in accordance with a program stored in the ROM 302 or a storage unit 305 and expanded in the RAM 303 to execute various processes.

The control unit 300 is connected to the storage unit 305, a display unit 306, an operation unit 307, a communication unit 308, and the like via the bus 304.

The storage unit 305 is implemented by an HDD, a flash memory, or the like, and maintains storage contents even when the power is cut off. The storage unit 305 stores various programs executed by the CPU 301 and various types of setting information related to the operation of the store terminal 30. The display unit 306 is a display device such as an LCD, and displays various types of information under control of the control unit 300. The operation unit 307 includes various operation buttons and outputs key information corresponding to an operation of an operator to the control unit 300. In the present embodiment, the operation unit 307 includes at least a touch panel on a surface of the display unit 306.

The communication unit 308 is a wired or wireless communication interface that can be connected to the network N. The communication unit 308 communicates with an external device such as the user terminal 10 or the server device 20 via the network N.

Next, functional configurations of the user terminal 10, the server device 20, and the store terminal 30 will be described. FIG. 8 is a diagram showing an example of the functional configurations of the user terminal 10, the server device 20, and the store terminal 30.

The user terminal 10 includes a communication control unit 151, a display control unit 152, an operation control unit 153, and an order assisting unit 154 as the functional configuration.

Some or all of the functional configurations of the user terminal 10 may be a software configuration implemented by cooperation of a processor (for example, the CPU 101) of the user terminal 10 and a program stored in a memory (for example, the ROM 102 and the storage unit 105). Some or all of the functional configurations of the user terminal 10 may be a hardware configuration implemented by a dedicated circuit or the like mounted on the user terminal 10.

The communication control unit 151 controls the communication unit 108 to communicate with an external device such as the server device 20 or the store terminal 30. The communication control unit 151 cooperates with another functional configuration to exchange information with the external device.

The display control unit 152 displays various types of information on the display unit 106. Specifically, the display control unit 152 displays a GUI related to the operation of the user terminal 10 on the display unit 106. The display control unit 152 cooperates with another functional configuration to display the GUI for assisting a merchandise order operation on the display unit 106.

The operation control unit 153 receives an operation of a user who operates the user terminal 10 via the operation unit 107. For example, the operation control unit 153 receives an operation for the GUI displayed by the display control unit 152. The operation control unit 153 receives an operation for a hardware key such as a keyboard.

The order assisting unit 154 executes a process for assisting an operation related to an order of merchandise sold in the store. For example, the order assisting unit 154 accesses the server device 20 in response to a user operation to acquire menu information on merchandise sold in the store from the server device 20. The order assisting unit 154 provides the user with a GUI for assisting the order of merchandise based on the acquired menu information.

Here, providing a GUI is a concept that includes not only a meaning of the order assisting unit 154 generating an operation screen based on information transmitted from the server device 20 and displaying the operation screen on the display unit 106, but also a meaning of the order assisting unit 154 displaying an operation screen generated by an order reception unit 252.

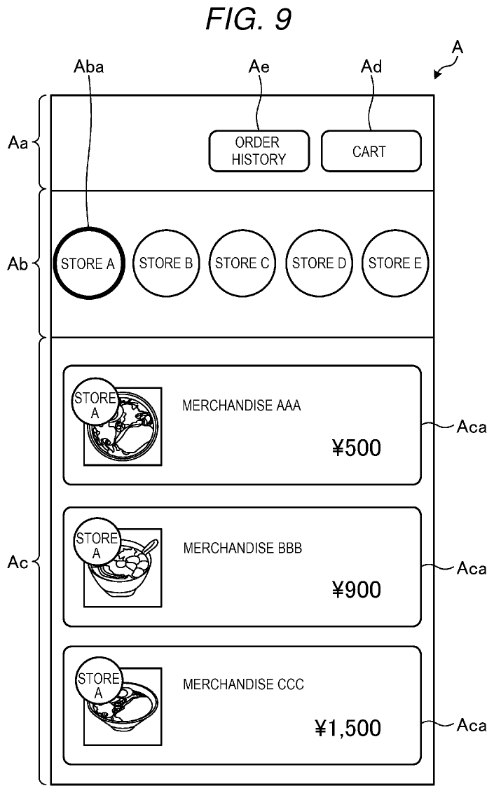

The GUI displayed by the order assisting unit 154 will be described below with reference to FIGS. 9 to 12. FIGS. 9 to 12 are diagrams showing examples of the GUI displayed on the display unit 106 of the user terminal 10. The GUI described below is generated and displayed by the order assisting unit 154 based on information or the like provided from the server device 20, but is not limited to this, and the order assisting unit 154 may display a screen generated by the server device 20.

Here, FIG. 9 is an example of a screen (merchandise selection screen) for assisting selection of the merchandise as the order target. As shown in FIG. 9, a merchandise selection screen A includes a first region Aa, a second region Ab, and a third region Ac.

Various operation elements related to a screen operation are displayed in the first region Aa. For example, a cart button Ad and an order history button Ae are displayed in the first region Aa. The operation element in the first region Aa will be described later.

In the second region Ab, a store name of a store and a store mark Aba indicating a logo mark of the store from which merchandise can be ordered are displayed. The store mark Aba functions as an operation element when selecting a store. If any one of the store marks Aba is selected, the order assisting unit 154 displays, on the third region Ac, information related to merchandise sold in the store based on the menu information of the store corresponding to the selected store mark Aba. The second region Ab can be scrolled in a left-right direction, and a store not displayed on the screen can be displayed by a scrolling operation.

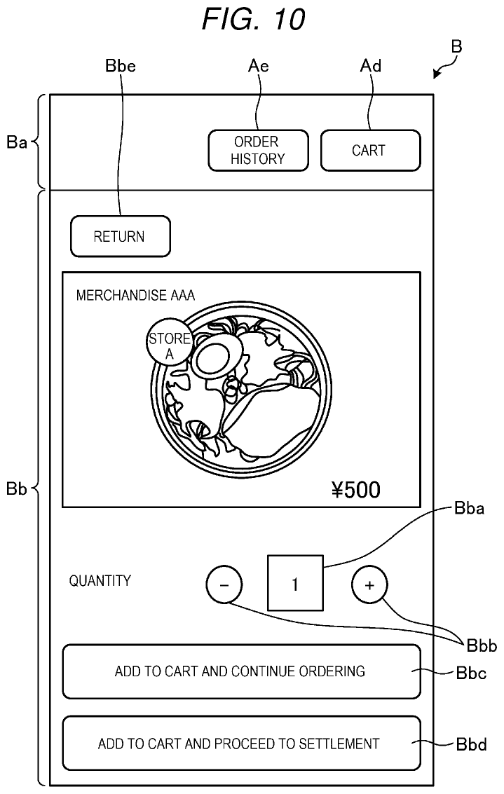

In the third region Ac, merchandise sold in the store selected in the second region Ab is displayed. FIG. 9 shows an example in which the store mark Aba of a store A is selected in the second region Ab, and merchandise sold at the store A is displayed in the third region Ac. In the third region Ac, a small region Aca in a rectangular shape is provided on a per merchandise item basis, and a merchandise name, a price, a merchandise image, a store name, and the like are displayed in the small region Aca. The small region Aca also functions as an operation element when selecting merchandise as the order target. For example, if any one of the small regions Aca is selected, the order assisting unit 154 displays the GUI shown in FIG. 10 on the display unit 106.

FIG. 10 is an example of a screen (merchandise confirmation screen) for confirming merchandise. A merchandise confirmation screen B includes a first region Ba and a second region Bb. Here, the cart button Ad and the order history button Ae are displayed in the first region Ba, similar to the first region Aa in FIG. 9.

In the second region Bb, information related to the merchandise selected in the third region Ac in FIG. 9 is displayed. Specifically, the merchandise name, the merchandise image, the price, the store name, and the like of the selected merchandise are displayed. Information related to the merchandise displayed in the second region Bb is not limited thereto. For example, information such as the merchandise description registered in the menu information may be displayed in the second region Bb.

The second region Bb is provided with a quantity region Bba for displaying a quantity of ordered merchandise and operation elements Bbb for increasing or decreasing the quantity. For example, if the operation element Bbb of a “+” mark is pressed, the quantity in the quantity region Bba is added in accordance with the number of times of pressing. An initial state of the quantity region Bba is set to “1”.

The second region Bb is provided with an operation element Bbc for instructing confirmation of an order. If the operation element Bbc is operated, the order assisting unit 154 correlates the merchandise ID of the merchandise displayed in the second region Bb, the quantity set in the quantity region Bba, and the store ID for selling the merchandise with each other, and stores the correlated information as order information in the RAM 103 or the like. Hereinafter, storing the order information in the RAM 103 or the like is also expressed as “adding to the cart” for convenience. Upon adding to the cart by an operation of the operation element Bbc, the order assisting unit 154 deletes the merchandise confirmation screen B and returns the display to the merchandise selection screen A to continue to assist selection of the merchandise as the order target.

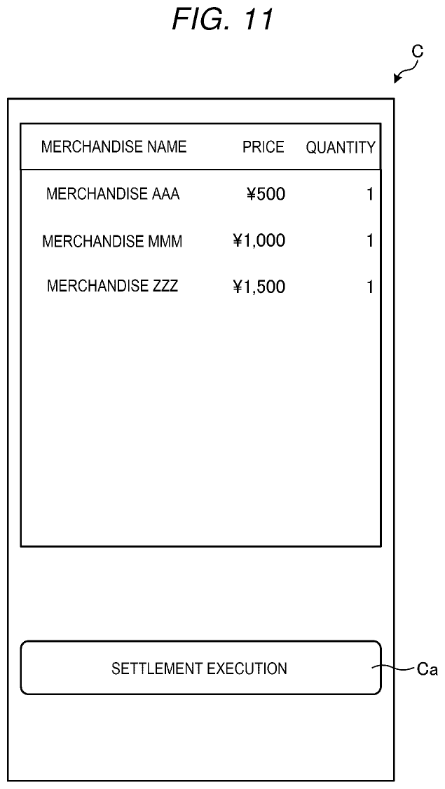

The second region Bb is provided with an operation element Bbd for instructing execution of settlement in addition to confirmation of the order. Upon receiving the operation of the operation element Bbd, the order assisting unit 154 adds the merchandise displayed in the second region Bb to the cart, and displays, for example, a GUI shown in FIG. 11, on the display unit 106.

An operation element Bbe for returning to the merchandise selection screen A is provided in the second region Bb. If the operation element Bbe is operated, the order assisting unit 154 deletes the merchandise confirmation screen B and returns the display to the merchandise selection screen A.

The cart button Ad provided in the first region Aa in the merchandise selection screen A (or in the first region Ba in the merchandise confirmation screen B) is an operation element operated when confirming the merchandise added to the cart. Upon receiving an operation of the cart button Ad, the order assisting unit 154 reads order information and displays, for example, the GUI shown in FIG. 11, on the display unit 106.

FIG. 11 is an example of a screen (hereinafter, also referred to as a cart screen) for confirming the merchandise added to the cart. On a cart screen C, order contents such as the merchandise names, prices, and quantities of merchandise added to the cart are displayed in an added order. The order content displayed on the cart screen C is not limited thereto, and other information such as a store name may be displayed.

The cart screen C is provided with a settlement execution button Ca for instructing execution of settlement. Upon receiving an operation of the settlement execution button Ca, the order assisting unit 154 cooperates with the server device 20 to pay a price of the merchandise in the order information by electronic settlement.

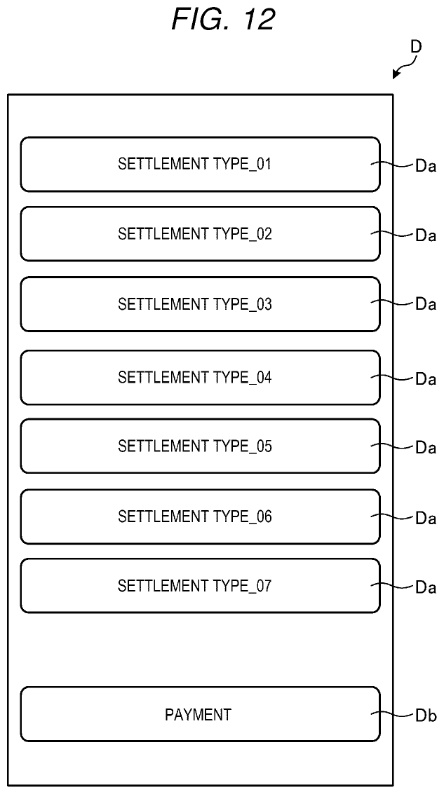

Specifically, upon receiving the operation of the settlement execution button Ca, the order assisting unit 154 transmits settlement information to be used for electronic settlement to the server device 20, together with the order information. Here, the settlement information includes at least information indicating a type of electronic settlement to be used (hereinafter also referred to as a settlement type). The settlement type is not particularly limited as long as the type is compatible with the server device 20 (settlement server 40). For example, in response to the operation of the settlement execution button Ca, the order assisting unit 154 may display, on the display unit 106, a GUI (see FIG. 12) in which the settlement type can be selected, and allow the user to select the settlement type.

FIG. 12 is an example of a screen (hereinafter, also referred to as a settlement type selection screen) for assisting selection of a settlement type. On a settlement type selection screen D, a list of settlement types for electronic settlement that is available by the server device 20 is displayed. Specifically, an operation element Da is displayed for each settlement type, and by operating a desired operation element Da, a corresponding settlement type is selected. FIG. 12 shows an example in which the settlement type to be used can be selected from seven types of settlement types, which are settlement type_01 to settlement type_07. In this case, the user can select the settlement type to be used by the user from the settlement type_01 to the settlement type_07.

Examples of the settlement type include credit card settlement in which settlement is performed using a credit card by associating the user terminal 10 with information on the credit card in advance, code settlement in which payment is performed in correlation with information on a financial account that is payment information on an owner of the user terminal 10, and carrier settlement in which payment is performed together with a use fee of a mobile telephone. A plurality of brands (types) may be set for the credit card settlement, the code settlement, and the carrier settlement.

The settlement type selection screen D is provided with a payment button Db that is an operation element for instructing confirmation of the settlement type. If an operation of the payment button Db is received after any one of the operation elements Da is selected, the order assisting unit 154 transmits settlement information related to the settlement type in the selected operation element Da to the server device 20.

The order information and the settlement information may be transmitted at the same time or at different timings. For example, the order assisting unit 154 may transmit order information at a timing at which the settlement execution button Ca is operated, and may transmit the settlement information at a timing at which the payment button Db is operated. The order assisting unit 154 may also transmit a terminal ID of its own user terminal 10 during transmission to the server device 20.

Upon receiving an order completion notification from the server device 20, the order assisting unit 154 adds an identifier such as a flag to the order information to manage the order information as completed order information. In the present embodiment, since a transaction ID is dispensed when receiving the order in the server device 20, the order assisting unit 154 adds the dispensed transaction ID to the order information to manage the order information as the completed order information.

Referring back to FIG. 9 or FIG. 10, the order history button Ae provided in the first region Aa (or in the first region Ba on the merchandise confirmation screen B) is an operation element used when displaying ordered merchandise. Upon receiving an operation of the order history button Ae, the order assisting unit 154 displays, on the display unit 106, an order content of the ordered merchandise based on the completed order information (not shown).

The order assisting unit 154 can also receive an operation of cancelling the order from the ordered merchandise. For example, upon receiving an operation of selecting merchandise as a cancellation target from the ordered merchandise displayed on the display unit 106, the order assisting unit 154 transmits cancellation information including information that can specify the selected merchandise and a transaction related to the order of the merchandise to the server device 20. For example, the order assisting unit 154 transmits cancellation information including a merchandise ID of the merchandise as the cancellation target, a store ID of the store in which the merchandise is sold, a transaction ID of the transaction, and the like to the server device 20.

The merchandise that can be cancelled is merchandise other than merchandise notified in a preparation completion notification to be described later among the ordered merchandise, that is, merchandise that is not prepared in the store. Further restrictions may be set to prevent cancellation due to an unreasonable operation such as mischief. For example, the order assisting unit 154 may perform control such as allowing a cancellation operation on merchandise that is already ordered within a predetermined time (within 5 minutes, or the like) after receiving the order completion notification from the server device 20.

The cancellation operation is not limited to being performed on a per merchandise basis, and may be performed on a per transaction basis. In this case, the order assisting unit 154 transmits cancellation information including the transaction ID as the cancellation target to the server device 20.

Referring back to FIG. 8, the functional configuration of the server device 20 will be described. As shown in FIG. 8, the server device 20 includes a communication control unit 251, the order reception unit 252, a settlement processing unit 253, and a cancellation processing unit 254 as the functional configuration.

Some or all of the functional configurations of the server device 20 may be a software configuration implemented by cooperation of a processor (for example, the CPU 201) of the server device 20 and a program stored in a memory (for example, the ROM 202 and the storage unit 205). Some or all of the functional configurations of the server device 20 may have a hardware configuration implemented by a dedicated circuit or the like mounted on the server device 20.

The communication control unit 251 controls the communication unit 206 to communicate with external devices such as the user terminal 10, the store terminal 30, and the settlement server 40. The communication control unit 251 cooperates with another functional configuration to exchange information with the external device.

The order reception unit 252 is an example of a first reception unit, a second reception unit, and a first notification unit. The order reception unit 252 executes various data processes related to the order of the merchandise. For example, upon receiving an access to the user terminal 10 from the user terminal 10, the order reception unit 252 provides information (or screen) related to display of the above various GUIs, such as menu information of merchandise sold in the store in the user terminal 10 as an access source. The order reception unit 252 receives order information and settlement information from the user terminal 10 to receive the order of the merchandise.

The settlement processing unit 253 is an example of a settlement unit. The settlement processing unit 253 cooperates with the settlement server 40 to execute a settlement process for the order information received by the order reception unit 252. Specifically, the settlement processing unit 253 executes settlement of the merchandise instructed by the order information based on the settlement information transmitted together with the order information.

More specifically, the settlement processing unit 253 calculates a total price of merchandise instructed by the order information based on the menu management table Tb. Next, the settlement processing unit 253 cooperates with the settlement server 40 to settle the total price of the merchandise as the order target with the settlement type instructed by the settlement information. According to the settlement, an amount of the price settled by a provider providing an electronic settlement service is deposited in a predetermined account such as an account managed by a food court or commercial facility.

If the settlement processing unit 253 completes the settlement, the order reception unit 252 dispenses a transaction ID to the order information for which the settlement is completed, and registers the order information and a terminal ID of the user terminal 10 that transmits the order information in the order management table Tc in correlation with each other. It is preferable that the order reception unit 252 stores a settlement ID or the like notified from the settlement server 40 when the settlement is completed in correlation with the transaction ID.

Next, the order reception unit 252 notifies the store terminal 30 in the store, in which the merchandise is sold, of an order content of the merchandise in the order information. Specifically, the order reception unit 252 extracts, based on a store ID in the order information, the order content (merchandise ID, number) of the ordered merchandise for each store ID. Next, the order reception unit 252 transmits the order content for each store ID extracted from the order information to the store terminal 30 in a store (store ID) corresponding to the store ID, together with the transaction ID.

The order reception unit 252 transmits an order completion notification to the user terminal 10 that transmits the order information by transmitting the dispensed transaction ID to the user terminal 10.

If the settlement process of the settlement processing unit 253 fails due to shortage of balance or the like, the order reception unit 252 prevents dispensing of the transaction ID, and notifies the user terminal 10 that transmits the order information that the settlement process is failed.

Upon receiving a preparation completion notification indicating the transaction ID from store terminal 30, the order reception unit 252 specifies order information corresponding to the instructed transaction ID from the order management table Tc. Next, the order reception unit 252 notifies the user terminal 10 corresponding to the terminal ID correlated with the specified order information that preparation of the merchandise is completed. Specifically, the order reception unit 252 notifies the user terminal 10 that preparation of a merchandise ID of the merchandise sold in the store with the store terminal 30 that transmits the preparation completion notification is completed among merchandise IDs of merchandise in the order information.

The cancellation processing unit 254 is an example of a third reception unit, an update unit, and a second notification unit. The cancellation processing unit 254 performs a process related to cancellation of ordered merchandise based on cancellation information transmitted from the user terminal 10. Specifically, based on the store ID in the cancellation information, the cancellation processing unit 254 specifies a store in which the merchandise whose order is cancelled is sold. Next, the cancellation processing unit 254 notifies the store terminal 30 in the specified store of cancellation of the order by informing a notification of the transaction ID and the merchandise ID in the cancellation information.

The cancellation processing unit 254 cooperates with the settlement processing unit 253 and the settlement server 40 to perform a process for cancelling settlement related to the transaction ID in the cancellation information. For example, the cancellation processing unit 254 instructs the settlement ID and the like notified from the settlement server 40 when performing settlement for the transaction ID to execute a process for cancelling settlement related to the settlement ID.

The cancellation processing unit 254 specifies order information as the cancellation target from the order management table Tc based on the cancellation information. Next, the cancellation processing unit 254 updates the order information by deleting the merchandise instructed by the cancellation information from the order information. The cancellation processing unit 254 cooperates with the settlement processing unit 253 to execute settlement again based on the updated order information.

Specifically, the settlement processing unit 253, under control of the cancellation processing unit 254, calculates a total price based on the updated order information and executes settlement again based on the total price. If the settlement information of the user is required when the settlement is executed again, the cancellation processing unit 254 may transmit information for requesting retransmission of the settlement information to the user terminal 10, which already transmits the cancellation information, to receive the settlement information again.

Next, the functional configuration of the store terminal 30 will be described. As shown in FIG. 8, the store terminal 30 includes a communication control unit 351, a display control unit 352, an operation control unit 353, and an order management unit 354 as the functional configuration.

Some or all of the functional configurations of the store terminal 30 may be a software configuration implemented by cooperation of a processor (for example, CPU 301) of the store terminal 30 and a program stored in a memory (for example, the ROM 302 and the storage unit 305). Some or all of the functional configurations of the store terminal 30 may have a hardware configuration implemented by a dedicated circuit or the like mounted on the store terminal 30.

The communication control unit 351 controls the communication unit 308 to communicate with an external device such as the user terminal 10 or the server device 20. The communication control unit 351 cooperates with another functional configuration to exchange information with the external device.

The display control unit 352 displays various types of information on the display unit 306. Specifically, the display control unit 352 displays a GUI related to an operation of the store terminal 30 on the display unit 306. The display control unit 352 cooperates with another functional configuration to display various GUIs on the display unit 306.

The operation control unit 353 receives an operation of an operator who operates the store terminal 30 via the operation unit 307. For example, the operation control unit 353 receives an operation for the GUI displayed by the display control unit 352. The operation control unit 353 receives an operation for a hardware key such as a keyboard.

The order management unit 354 receives a notification of the ordered merchandise from the server device 20. Specifically, upon receiving a notification of an order content from the server device 20, the order management unit 354 displays the order content on the display unit 306. For example, the order management unit 354 displays a merchandise name, a quantity, a transaction ID, and the like of ordered merchandise.

Upon receiving a predetermined operation instructing that preparation for cooking or the like is completed on the merchandise displayed on the display unit 306, the order management unit 354 notifies the server device 20 that preparation of the ordered merchandise is completed. Specifically, if the preparation of the merchandise in one transaction is completed, the order management unit 354 transmits a preparation completion notification instructing the transaction ID of the transaction to the server device 20.

Upon receiving a cancellation notification indicating a transaction ID and a merchandise ID as the cancellation target of an order from the server device 20, the order management unit 354 executes a process for informing the store clerk that the order of the merchandise instructed by the notification is cancelled. For example, the order management unit 354 performs highlighted display by adding a strikethrough or the like to the merchandise instructed to be cancelled or displaying the merchandise in red. The order management unit 354 displays, on the display unit 306, a message informing the store clerk that cancellation of the order is instructed by a pop-up or the like.

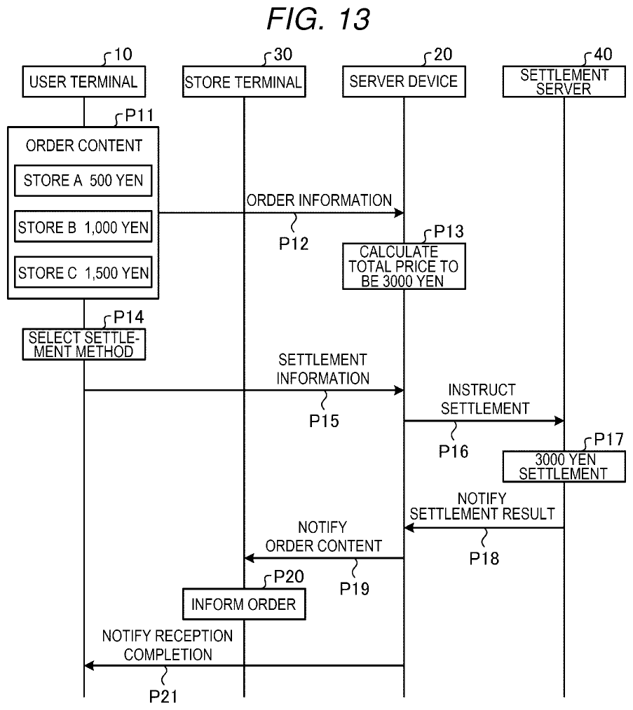

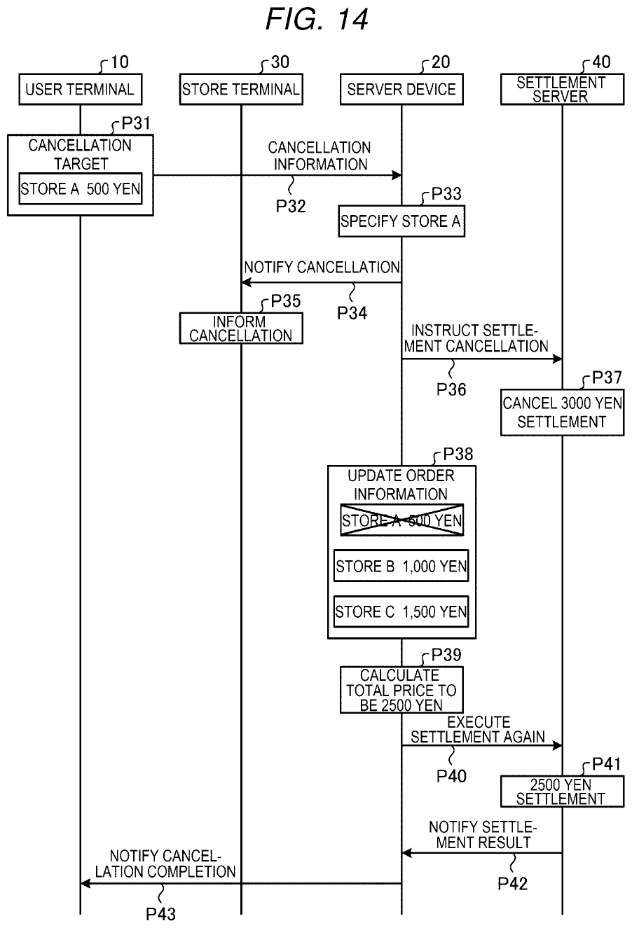

Next, an operation example of the above order system 1 will be described with reference to FIGS. 13 and 14. Here, FIGS. 13 and 14 are diagrams explaining operation examples of the order system 1.

First, a flow of operations when an order of merchandise is performed will be described with reference to FIG. 13. If the user terminal 10 determines merchandise as an order target by a user operation (ACT P11), the order assisting unit 154 transmits order information including an order content to the server device 20 (ACT P12). FIG. 13 shows an example in which 500 yen merchandise sold by the store A, 1,000 yen merchandise sold by a store B, and 1500 yen merchandise sold by a store C are transmitted in one piece of order information as the order content.

In the server device 20, if the order information is received, the settlement processing unit 253 calculates a total price of the merchandise instructed by the order information (ACT P13). In the example in FIG. 13, the settlement processing unit 253 calculates a total price to be 3000 yen.

In the user terminal 10, if a settlement type is selected by a user operation (ACT P14), the order assisting unit 154 transmits the settlement information instructing the selected settlement type to the server device 20 (ACT P15).

In the server device 20, if the settlement information is received, the settlement processing unit 253 instructs the settlement server 40 to perform the 3000 yen settlement calculated in ACT P13 with the settlement type instructed by the settlement information (ACT P16). Accordingly, the settlement server 40 executes the 3000 yen settlement with the instructed settlement type (ACT P17), and notifies the server device 20 of a settlement result (ACT P18).

In the server device 20, upon confirming that the settlement is normally executed based on the notification from the settlement server 40, the order reception unit 252 stores the order information and the like in the order management table Tc in correlation with a newly dispensed transaction ID. Next, the order reception unit 252 notifies the store terminal 30 in the store A to the store C from which the merchandise is ordered of the order content based on the order information for which the settlement is completed (ACT P19). Accordingly, the order management unit 354 of the store terminal 30 displays the notified order content on the display unit 306 to inform the store clerk that the order is placed (ACT P20).

The order reception unit 252 transmits the transaction ID and the like to the user terminal 10 to notify the user terminal 10 of completion of order reception (ACT P21). In the user terminal 10, the order assisting unit 154 stores the order information in correlation with the transaction ID in response to the notification from the server device 20, thereby managing the order information as completed order information.

Thus, in the order system 1, if merchandise is ordered over a plurality of stores from the user terminal 10, the server device 20 performs batch settlement of the ordered merchandise with the settlement type designated by the user terminal 10. Accordingly, the user of the user terminal 10 can perform settlement of the ordered merchandise using the desired settlement type without being aware of the settlement type that can be used in each store. Therefore, in the order system 1, convenience for an order and settlement of merchandise sold in a plurality of stores can be improved.

Next, an operation flow when an order is cancelled will be described with reference to FIG. 14. Merchandise as the cancellation target is instructed on the user terminal 10 by a user operation (ACT P31). The order assisting unit 154 transmits cancellation information including a merchandise ID of the merchandise or the like to the server device 20 (ACT P32). FIG. 14 shows an example in which cancellation of the 500 yen merchandise sold in the store A among the merchandise ordered in FIG. 13 is instructed.

In the server device 20, if the cancellation information is received, the cancellation processing unit 254 specifies a store in which the merchandise for which the order is cancelled, based on a store ID in the cancellation information (ACT P33). FIG. 14 shows an example in which the store A is specified in ACT P33.

Next, the cancellation processing unit 254 notifies the store terminal 30 in the specified store of the cancellation of the order by informing a notification of the transaction ID and the merchandise ID in the cancellation information (ACT P34). Accordingly, the order management unit 354 of the store terminal 30 displays the notified content on the display unit 306 to inform the store clerk that the order is cancelled (ACT P35).

Subsequently, the settlement processing unit 253 instructs, under control of the cancellation processing unit 254, the settlement server 40 to cancel the settlement in order to cancel settlement of a transaction corresponding to the transaction ID instructed by the transaction information (ACT P36). Accordingly, the settlement server 40 cancels settlement of the instructed transaction (ACT P37). FIG. 14 shows an example in which the 3000 yen settlement performed in ACT P17 in FIG. 13 is cancelled.

Subsequently, the cancellation processing unit 254 specifies, from the order management table Tc, order information corresponding to the transaction ID instructed by the cancellation information, and edits the order information according to the cancellation information to update the order information (ACT P38). FIG. 14 shows an example in which the 500 yen merchandise ordered in the store A is deleted from the order content shown in ACT P11 in FIG. 13.

Subsequently, the settlement processing unit 253 calculates a total price of merchandise instructed by the updated order information under the control of the cancellation processing unit 254 (ACT P39). FIG. 14 shows an example in which 2,500 yen, excluding 500 yen in the store A, is calculated as the total price.

Subsequently, the settlement processing unit 253 instructs, under the control of the cancellation processing unit 254, the settlement server 40 to execute settlement again based on the 2, 500 yen calculated in ACT P39 (ACT P40). Accordingly, the settlement server 40 executes the 2,500 yen settlement with the instructed settlement type (ACT P41), and notifies the server device 20 of a settlement result (ACT P42).

Then, in the server device 20, upon confirming that the settlement is normally executed based on the notification from the settlement server 40, the cancellation processing unit 254 notifies the user terminal 10 that cancellation of the order instructed by the cancellation information is completed (ACT P43).

Thus, in the order system 1, if cancellation of the ordered merchandise is instructed from the user terminal 10, the server device 20 cancels settlement of a transaction related to the order, and then performs batch settlement of the merchandise again based on the order information from which the instructed merchandise is deleted. Accordingly, in the order system 1, for example, as shown in FIG. 14, if cancellation of the order for the store A is instructed, an order for the store A can be cancelled and orders for the stores B and C can be maintained. Therefore, in the order system 1, even if instructions are given to cancel some of the merchandise ordered over a plurality of stores, it is possible to efficiently cancel the instructed merchandise. In the order system 1, convenience for an order and settlement of merchandise sold in a plurality of stores can be improved.

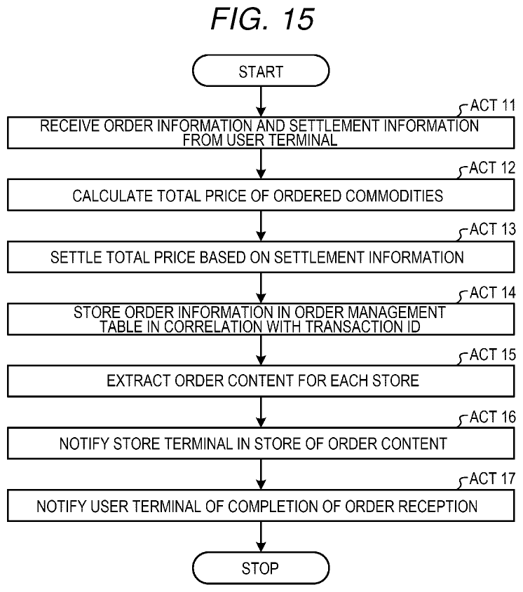

Hereinafter, an example of a process performed by the server device 20 will be described. FIG. 15 is a flowchart showing an example of order reception performed by the server device 20.

First, the order reception unit 252 receives order information and settlement information from the user terminal 10 (ACT 11). Next, the settlement processing unit 253 calculates a total price of merchandise in the order information based on the menu management table Tb (ACT 12). Next, the settlement processing unit 253 settles the total price calculated in ACT 12 based on the settlement information received in ACT 11 (ACT 13).

If a settlement process is completed, the order reception unit 252 dispenses a transaction ID and stores order information and the like in the order management table Tc in correlation with the dispensed transaction ID (ACT 14).

Subsequently, the order reception unit 252 extracts an order content of ordered merchandise for each store ID based on the store ID in the order information (ACT 15). Next, the order reception unit 252 notifies the store terminal 30 in the store corresponding to the store ID of the order content for each extracted store ID together with the transaction ID (ACT 16).

Subsequently, the order reception unit 252 transmits the transaction ID and the like dispensed in ACT 14 to the user terminal 10 that transmits the order information, thereby notifying the user terminal 10 of completion of order reception (ACT 17), and ends this process.

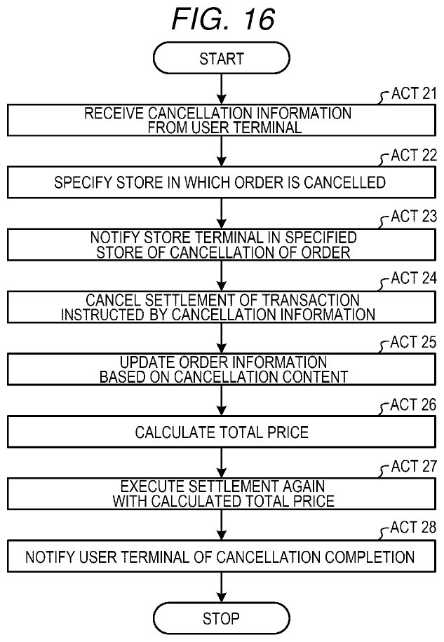

FIG. 16 is a flowchart showing an example of order cancellation performed by the server device 20.

First, the cancellation processing unit 254 receives cancellation information from the user terminal 10 (ACT 21). Next, the cancellation processing unit 254 specifies a store in which the merchandise instructed to be cancelled is sold, based on the store ID and the like in transaction information (ACT 22). Next, the cancellation processing unit 254 notifies the store terminal 30 in the specified store of the transaction ID and a merchandise ID instructed by the transaction information to notify the store terminal 30 of cancellation of the order (ACT 23).

Subsequently, in order to cancel settlement of a transaction corresponding to the transaction ID instructed by the cancellation information, the settlement processing unit 253 instructs the settlement server 40 to cancel the settlement (ACT 24). Next, the cancellation processing unit 254 updates the order information corresponding to the transaction ID instructed by the cancellation information according to a cancellation content instructed by the cancellation information (ACT 25).

Subsequently, the settlement processing unit 253 calculates a total price of merchandise in the updated order information (ACT 26), and executes settlement again with the calculated total price (ACT 27).

Then, the cancellation processing unit 254 notifies the user terminal 10 that transmits the cancellation information that cancellation of the order is completed (ACT 28), and ends this process.

As described above, if an order of merchandise over a plurality of stores is performed from the user terminal 10, the server device 20 performs batch settlement of the ordered merchandise with the settlement type designated by the user terminal 10. Accordingly, the user of the user terminal 10 can perform settlement of the ordered merchandise using the desired settlement type without being aware of the settlement type that can be used in each store. Therefore, in the server device 20, convenience related to an order and settlement of merchandise sold in a plurality of stores can be improved.

If cancellation of the ordered merchandise is instructed from the user terminal 10, the server device 20 cancels settlement of a transaction related to the order, and then performs batch settlement of the merchandise again based on the order information from which the instructed merchandise is deleted. Accordingly, even if instructions are given to cancel some of the merchandise ordered over a plurality of stores, the server device 20 can efficiently cancel the instructed merchandise. Therefore, in the server device 20, convenience related to an order and settlement of merchandise sold in a plurality of stores can be improved.

The embodiment described above can be appropriately modified and implemented by changing a part of the configuration or functions of the devices described above. Hereinafter, some modifications according to the above-described embodiment will be described as other embodiments. Hereinafter, points different from the above-described embodiment will be mainly described, and detailed description of points common to the already described contents will be omitted. The modifications described below may be implemented individually or may be implemented in combination as appropriate.

### First Modification

In the embodiment described above, a configuration in which batch settlement of the merchandise is performed if the order of the merchandise is performed over a plurality of stores is described. Thereafter, the total price of the merchandise paid by the settlement is distributed to each store in which the merchandise is sold, and may be counted as a profit for each store. Therefore, in this modification, description will be given of a configuration in which, after settlement of merchandise is performed, a price corresponding to an order is paid to each store.

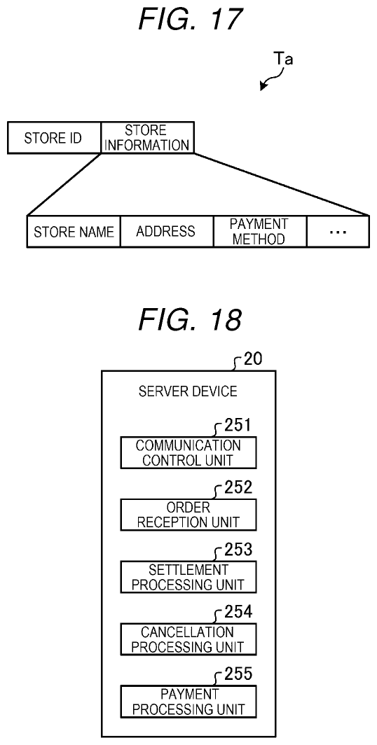

FIG. 17 is a diagram showing an example of a data configuration of the store information table Ta according to this modification. As shown in FIG. 17, the store information table Ta according to this modification stores store information related to the store in correlation with the store ID.

The store information includes a payment method item in addition to the above-described items such as the store name and the address. In the payment method item, in addition to a payment method for a price that can be used at the store, payee information including information instructing payment destination is registered. Here, the payment method can be set to a type of electronic settlement service such as electronic money settlement or credit card settlement, similar to the settlement type.

FIG. 18 is a diagram showing an example of a functional configuration of the server device 20 according to this modification. As shown in FIG. 18, the server device 20 further includes a payment processing unit 255 in addition to the functional configuration described with reference to FIG. 8.

If the settlement processing unit 253 completes settlement, the payment processing unit 255 executes payment for paying a price of the ordered merchandise to the store in which the merchandise is sold based on the order information as a settlement target.

Specifically, the payment processing unit 255 specifies a payment method that can be used in the store ID from the store information table Ta based on the store ID in the order information. The payment processing unit 255 calculates a price for each store for the ordered merchandise (hereinafter, also referred to as a store total price) based on the order content (merchandise ID, number) of the merchandise in the order information and the menu management table Tb. Next, the payment processing unit 255 cooperates with the settlement processing unit 253 to settle or send the calculated store total price for each store using the payment method of the store, thereby paying the price of the ordered merchandise to the store where the order is placed.

The payment of the price to the store may be made each time the order information is registered in the order management table Tc, or may be made at a predetermined timing such as once a day for all order information registered in the order management table Tc up to that point.

In the former case, for example, if cancellation of merchandise is instructed by cancellation information, the payment processing unit 255 cooperates with the cancellation processing unit 254 to cancel payment performed on a store in which the merchandise is sold in a transaction related to the merchandise as the cancellation target. Then, after update of the order information, if a store total price for the store in which the payment is cancelled remains, the payment processing unit 255 makes payment to the store again.

In the latter case, the payment processing unit 255 may execute payment for each order information registered in the order management table Tc, or may calculate a sum of store total prices for each store based on a plurality of pieces of order information, and execute payment of paying the sum of the store total prices at once.

According to the order system 1 in this modification, it is possible to perform a series of processes up to distribution of a store profit determined by the settlement, without being limited to a process from the order reception to the settlement of the merchandise. Therefore, it is possible to more efficiently operate a plurality of stores described above.

### Second Modification

In the above-described embodiment, a mode in which order cancellation information is transmitted from the user terminal 10 is described, but the present disclosure is not limited to this, and the cancellation information may be transmitted from the store terminal 30. In this case, in the store with the store terminal 30, in response to a request from the user using the user terminal 10, an employee such as a store clerk operates the store terminal 30 to perform a process for cancelling merchandise as instructed by the user.

Specifically, upon receiving a merchandise cancellation operation from the employee, the order management unit 354 transmits, to the server device 20, cancellation information including information that enables identification of the merchandise and the transaction as a cancellation target, such as a merchandise ID and a transaction ID of the merchandise to be operated and a store ID of the own store.

Based on the cancellation information transmitted from the store terminal 30, the cancellation processing unit 254 of the server device 20 cancels the order by updating the order information and executing the settlement again using the updated total price.

According to the order system 1 in this modification, an order cancellation instruction can be given via the store terminal 30. Accordingly, in the order system 1 in this modification, even if cancellation of the order by the user terminal 10 is invalidated, an order cancellation instruction can be given via the store terminal 30.

### Third Modification

In the above-described embodiment, the server device 20 receives an order from the store that is located in the same commercial facility (food court), but a target store is not limited to this. For example, the server device 20 may receive an order in a store outside the commercial facility.

### Fourth Modification

In the above-described embodiment, by explicitly including the store ID in the order information and cancellation information, a store to which an order is placed and a store as an order cancellation target can be specified based on the store ID. However, the present disclosure is not limited to this configuration, and a configuration may also be adopted in which the store ID is not explicitly included in the order information and cancellation information. In this case, the server device 20 may specify a store (store ID) corresponding to the merchandise ID based on the merchandise ID in the order information and the cancellation information based on the menu management table Tb.

### Fifth Modification

In the above-described embodiment, if preparation for ordered merchandise is completed, the preparation completion notification is transmitted to the user terminal 10 via the server device 20, but the present disclosure is not limited thereto, and a configuration may be adopted in which the preparation completion notification is transmitted directly from the store terminal 30 in the store to the user terminal 10.

In this case, for example, when the order content is notified from the server device 20 to the store terminal 30, the store terminal 30 is notified of the terminal ID correlated with the order information in the order content, thereby enabling a notification from the store terminal 30 to the user terminal 10.

A program executed by the device in the above-described embodiment is provided by being incorporated in advance in a ROM or the like. The program executed by the device in the above-described embodiment may be provided by being recorded in a computer-readable recording medium such as a CD-ROM, a flexible disk (FD), a CD-R, or a digital versatile disk (DVD) as a file in an installable or executable format.

Further, the program executed by the device in the above-described embodiment may be stored in a computer connected to a network such as the Internet and provided by being downloaded via the network. The program executed by the device in the above-described embodiment may be provided or distributed via a network such as the Internet.

While certain embodiments are described, these embodiments are presented by way of example only, and are not intended to limit the scope of the disclosure. The novel embodiments described herein may be embodied in a variety of other forms; and various omissions, substitutions, changes, and combinations in the form of the embodiments described herein may be made without departing from the spirit of the disclosure. The embodiments and the modifications thereof are included in the scope and the spirit of the disclosure, and are included in a scope of the invention disclosed in the claims and equivalents thereof.

What is claimed is:

1. A server device, comprising:
a first reception component configured to receive, from a user terminal, order information instructing merchandise as an order target selected from merchandise sold in a plurality of stores;
a second reception component configured to receive, from the user terminal, a settlement type instructing a settlement method for the merchandise; and
a settlement component configured to settle a total price of the merchandise instructed by the order information with the indicated settlement type.

2. The server device according to claim 1, wherein
the second reception component provides the user terminal with a screen that allows selection of one settlement type from among a plurality of settlement types, and receives the settlement type selected from the screen from the user terminal.

3. The server device according to claim 1, further comprising:
a first notification component configured to notify a store terminal in a store in which the merchandise instructed by the order information is sold of an order content of the merchandise after the settlement is completed.

4. The server device according to claim 1, further comprising:
a third reception component configured to receive, from the user terminal, cancellation information instructing merchandise as a cancellation target of an order and order information related to the merchandise; and
an update component configured to update order information by deleting the merchandise as the cancellation target based on the order information instructed by the cancellation information, wherein
the settlement component cancels settlement of the order information instructed by the cancellation information, and then performs the settlement again based on a total price of merchandise instructed by updated order information.

5. The server device according to claim 4, further comprising:
a second notification component configured to notify a store in which the merchandise instructed by the cancellation information is sold of a cancellation notification of the merchandise.

6. The server device according to claim 1, wherein
the order information comprises at least one of a merchandise ID, a merchandise name, a price, merchandise description, and a merchandise image.

7. The server device according to claim 1, wherein
the user terminal is a point of sale terminal.

8. A method, comprising:
receiving, from a user terminal, order information instructing merchandise as an order target selected from merchandise sold in a plurality of stores;
receiving, from the user terminal, a settlement type instructing a settlement method for the merchandise; and
settling a total price of the merchandise instructed by the order information with the instructed settlement type.

9. The method according to claim 8, further comprising:
providing the user terminal with a screen that allows selection of one settlement type from among a plurality of settlement types; and
receiving the settlement type selected from the screen from the user terminal.

10. The method according to claim 8, further comprising:
notifying a store terminal in a store in which the merchandise instructed by the order information is sold of an order content of the merchandise after the settlement is completed.

11. The method according to claim 8, further comprising:
receiving, from the user terminal, cancellation information instructing merchandise as a cancellation target of an order and order information related to the merchandise;
updating order information by deleting the merchandise as the cancellation target based on the order information instructed by the cancellation information;
cancelling settlement of the order information instructed by the cancellation information; and
performing the settlement again based on a total price of merchandise instructed by updated order information.

12. The method according to claim 11, further comprising:
notifying a store in which the merchandise instructed by the cancellation information is sold of a cancellation notification of the merchandise.

13. The method according to claim 8, wherein
the order information comprises at least one of a merchandise ID, a merchandise name, a price, merchandise description, and a merchandise image.

14. A non-transitory computer readable storage medium storing a program that causes a computer to execute instructions comprising:
receiving, from a user terminal, order information instructing merchandise as an order target selected from merchandise sold in a plurality of stores;
receiving, from the user terminal, a settlement type instructing a settlement method for the merchandise; and
settling a total price of the merchandise instructed by the order information with the instructed settlement type.

15. The non-transitory computer readable storage medium according to claim 14, further comprising:
providing the user terminal with a screen that allows selection of one settlement type from among a plurality of settlement types; and
receiving the settlement type selected from the screen from the user terminal.

16. The non-transitory computer readable storage medium according to claim 14, further comprising:
notifying a store terminal in a store in which the merchandise instructed by the order information is sold of an order content of the merchandise after the settlement is completed.

17. The non-transitory computer readable storage medium according to claim 14, further comprising:
receiving, from the user terminal, cancellation information instructing merchandise as a cancellation target of an order and order information related to the merchandise;
updating order information by deleting the merchandise as the cancellation target based on the order information instructed by the cancellation information;
cancelling settlement of the order information instructed by the cancellation information; and
performing the settlement again based on a total price of merchandise instructed by updated order information.

18. The non-transitory computer readable storage medium according to claim 17, further comprising:
notifying a store in which the merchandise instructed by the cancellation information is sold of a cancellation notification of the merchandise.

19. The non-transitory computer readable storage medium according to claim 14, wherein
the order information comprises at least one of a merchandise ID, a merchandise name, a price, merchandise description, and a merchandise image.

20. The non-transitory computer readable storage medium device according to claim 14, wherein
the user terminal is a point of sale terminal.
